(19) United States
(12) Patent Application Publication
(10) Pub. No.: US 2008/0201464 A1
(43) Pub. Date: Aug. 21, 2008

(54) PREVENTION OF FRAUD IN COMPUTER NETWORK

(76) Inventors: Steven R. CAMPBELL, Mississauga (CA); Andre S. CHIU, North York (CA); Adam W. CHOW, Mississauga (CA)

Correspondence Address: TORYS LLP, 79 WELLINGTON ST. WEST, SUITE 3000, TORONTO, ON, M5K 1N2, omitted

(21) Appl. No.: 11/425,262

(22) Filed: Jun. 20, 2006

(51) Int. Cl. G06F 15/16

(52) U.S. Cl. 709/224

(57) ABSTRACT

Systems, methods, and computer programming media useful in the identification and prevention of fraudulent activity on computer networks. In various aspects the invention provides methods, systems, and programming for monitoring requests received by network resources for access to data by remote signal sources. Signal source identifiers such as URLs associated with original and referred data requests are checked for satisfaction of one or more trustworthiness criteria. If the network identifier associated with the remote signal source does not satisfy the trustworthiness criteria, data associated with the untrusted signal source is assessed to determine whether it comprises fraudulent or suspicious content. If the data comprises fraudulent or suspicious content, the source of the data can be referred for further investigation or enforcement action, either by the operator or processor assessing the data, or by a network enforcement resource such as network standards or law enforcement agencies.

### BACKGROUND

Internet and other forms of computer network fraud represent significant threats to legitimate intercourse via computer networks. It is well known, for example, that perpetrators of fraud commonly induce unsuspecting network users to disclose confidential information such as details of credit card accounts through the use of deceptive e-mails, particularly through the use of unsolicited commercial e-mail, which is often colloquially referred to as “spam”.

Many attempts to eliminate or control fraudulent communications such as e-mails have been made, with greater or lesser degrees of success. Such attempts have typically involved the investigation of network resources accessible through hypertext links or other information embedded or otherwise provided within the fraudulent communications. A summary of many such attempts has been provided in the ITTC Report on Online Identity Theft Technology and Countermeasures, published in October 2005, the entire contents of which are incorporated by this reference.

A shortcoming common to such attempts, however, is that they have been reactive rather than proactive. That is, they are effective only in response to fraudulent activities that have already been implemented. For example, the contents of a fraudulent e-mail are examined, and content to which a reader of the e-mail is referred or re-directed are investigated. Such e-mails are not sent, however, until the fraudulent resources to which they direct users are already operational. It is impractical to expect that an enforcer or other investigator can investigate the fraudulent activity and take corrective action before significant fraudulent activity has already taken place.

Until the provision of the invention disclosed herein, there has been no effective means of combating fraudulent activities while they are in their formative or initial operational stages, before significant damage has been done.

One type of fraud, for example, involves the creation of fraudulent network sites in order to induce legitimate network users to disclose confidential information such as credit card data in such a way that the operator of the fraudulent site can record and later use or sell the information. For example, a “Pharmer” might set up a network site bearing a convincing resemblance to a legitimate site, and thereafter route legitimate traffic to the legitimate site, as for example by providing hypertext or other links to the legitimate site, so as to record confidential information as it is disclosed to the legitimate site in a commercial transaction. The misappropriation of confidential information can also be used to perpetrate identity theft, which is a rapidly growing pattern of crime.

Among other shortcomings, prior art approaches have not provided means for identifying fraudulent network sites before fraudulent activities have begun, or in the initial stages of operation, or for identifying legitimate customers whose confidential information may have been comprised by unwitting use of the fraudulent network site.

### SUMMARY OF THE INVENTION

The invention relates to the identification and prevention of fraudulent activity on computer networks. The invention provides, for example, systems, methods, and programming for verifying the authenticity of referring resources in a computer network, investigating the content of suspicious network resources, and, when appropriate, identifying fraudulent network resources for enforcement action.

Among other advantages, such systems, methods, and program enable the identification of fraudulent network sites, or other resources, and the operators of such resources before fraudulent activities begin, or in the initial stages of deception, and enable the identification of legitimate network users whose confidential information may have been comprised by unwitting use of the fraudulent network site.

In one aspect, the invention provides methods of identifying potentially fraudulent activity on a computer network. The methods are performed partly or wholly by computers or other automatic data processors. A data processor receives a communication signal over a network from a remote signal source, which may be an originator of the signal or an intermediate referring resource (or referrer). The signal represents any request for access by the originating or referral signal source to data, and includes one or more network identifiers, such as a uniform resource locators (URLs), associated with the remote signal source. The processor determines whether the network identifier satisfies one or more trustworthiness criteria. If the network identifier associated with the remote signal source does not satisfy the trustworthiness criteria, the processor accesses data associated with the remote signal source. The accessed data can be reviewed automatically and/or by a human operator to determine whether it comprises fraudulent or suspicious content. If the data comprises fraudulent or suspicious content, the source of the data can be referred for further investigation or enforcement action, either by the operator or processor assessing the data, or by a network enforcement resource such as network standards or law enforcement agencies.

For example, an operator of an Internet website, such a bank or other entity which conducts commercial transactions over a network, can review inquiry signals such as website “hits” received from other computers communicatively linked to the network. Such inquiry signals are frequently provided in the form of formatted data strings which include identifiers associated with the remote original and/or referring source(s) of the signal. Such identifiers can include, for example, encoded addresses such as URLs assigned in accordance with the Hypertext Transfer Protocol (HTTP). Such addresses can serve to uniquely identify the remote signal sources from which inquiries are received.

Sources of inquiries and other signals can include both primary and secondary sources. Primary signal sources can include, for example, an originating resource, as for example a legitimate user of a network. Secondary sources and include referring or other intermediate resources. A referring resource, for example, is a network site or other device which receives an original signal and causes an inquiry or other signal, or subsequent signals received from an originating resource, to be directed to a third-party target of an inquiry. Examples include advertisers, search engines, and business venture partners.

An operator of a network site such as a potential target site, or a security monitor or other resource associated with a potential target site, can provide for the automatic review of all inquiries received by the operator's host server, and determine whether there is any reason to suspect the inquiring signal source as being referred by or otherwise connected with any possibly fraudulent activity.

For example, an operator of an e-commerce website such as a bank, retailer, or charity frequently receives inquiry signals from a variety of legitimate referrers, such as network search resources such as Google, Lycos, various Yellow Pages and other references resources, business partners, and advertisers, some of which are new and previously unknown to the website operator, and others of which may have been previously known or recognized, and therefore perhaps trusted. Other inquiries are received from constructors of fraudulent web sites who are “Phishing” targeted websites to steal content presented on or disclosed to the target website, through the use of convincing fraudulent websites designed to induce unsuspecting network users to disclose sensitive, confidential, or commercially useful information, which may be recorded or otherwise co-opted by the fraudulent site operator, for example to purchase goods or services through fraud, or to engage in identity theft. By monitoring incoming data requests investigating unknown or otherwise suspicious inquiry sources, the inventors have discovered that it is often possible to catch the constructors of such fraudulent websites before substantial injury has occurred.

A wide variety of criteria may be used, alone or in combination, to assess the trustworthiness of referral or originating inquiry sources. For example, the inclusion of a signal source identifier on a list of previously-established or otherwise recognized customers or business partners, or otherwise previously-authorized resources (e.g., a “white list”), will serve. Alternatively, inclusion of a signal source identifier on a list of resources previously identified as associated with suspicious activity (e.g., a “black list”) will serve. In addition, a wide variety of signal traffic analysis tools and algorithms may be used. Any criteria consistent with the purposes and processes disclosed herein will serve.

A remote signal source can include any computer or other data processor or other device capable of producing an inquiry or other communication signal capable of causing the source to be granted access to any data controlled by or otherwise associated with a target network resource, and can comprise either originating, or primary; or referring or other intermediate sources; or both.

Network identifiers can be of any type of signal suitable for the purposes described herein. For example, a wide variety of data used in conjunction with known protocols, such as the Hypertext Transfer Protocol (HTTP), will serve, and can identify any primary and/or secondary signal sources.

Investigation of signal sources determined to be untrusted can be made in real time, near real time, or after a delay of any desired duration. For example, confirmation of an inquiry source as trustworthy can be made a condition of access to the operator's network resources, as for example during a log-in or other authentication process. Alternatively, as for example where it is not desired to slow a user authentication process, it can be advantageous to assemble sets of identifiers for batch or other more or less “off-line” or delayed processing. For example, by monitoring identifiers of incoming inquiries and holding data corresponding to such identifiers in a buffer or other data set, it is possible to allow legitimate users to access the operators' resources without delay. In such circumstances suitable periods for delay, or establishment of suitable time limits for confirmation or other investigative follow up can be used to minimize harm done by the implementation of fraudulent websites. It has been found, for example, that checking the source of each incoming inquiry within a few minutes, as for example within 15 minutes or half an hour, can provide effectively rapid response.

When a signal source has been determined to be suspicious, or otherwise untrusted, any data associated with the untrusted inquiry source can be accessed and reviewed to determine whether the content is suspicious. Such access and review can be performed automatically and/or by a human operator. For example, the content can be accessed by automatic image or content recognition equipment or processes, and/or displayed on display screen or other output device to determine whether in includes trademarks, logos, product descriptions, or other text or image content useable for presentation of a deceptive website.

If the data is determined to comprise fraudulent or suspicious content, the source of the data can be referred for further investigation or enforcement action.

In other embodiments and aspects, the invention provides systems, devices, and programming media suitable for use in implementing or facilitating the performance of such methods.

### BRIEF DESCRIPTION OF THE FIGURES

The invention is illustrated in the figures of the accompanying drawings, which are meant to be exemplary and not limiting, and in which like references are intended to refer to like or corresponding parts.

FIGS. 1a-1c are schematic diagrams of a computer network systems comprising components suitable for use in implementing the invention.

FIGS. 2a and 2b are schematic flowcharts of methods of identifying potentially fraudulent activity on a computer network in accordance with the invention.

FIGS. 3a-3e are schematic diagrams of user interface display screens suitable for use in implementing the invention.

### DETAILED DESCRIPTION OF THE PREFERRED EMBODIMENTS

Preferred embodiments of methods, systems, and apparatus according to the invention are described through reference to the Figures.

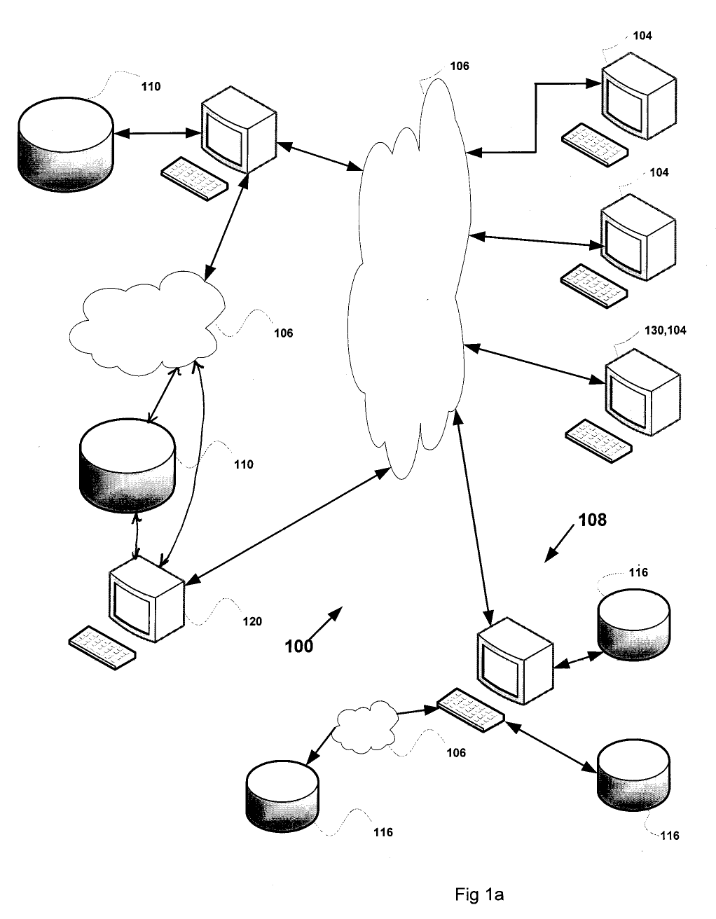

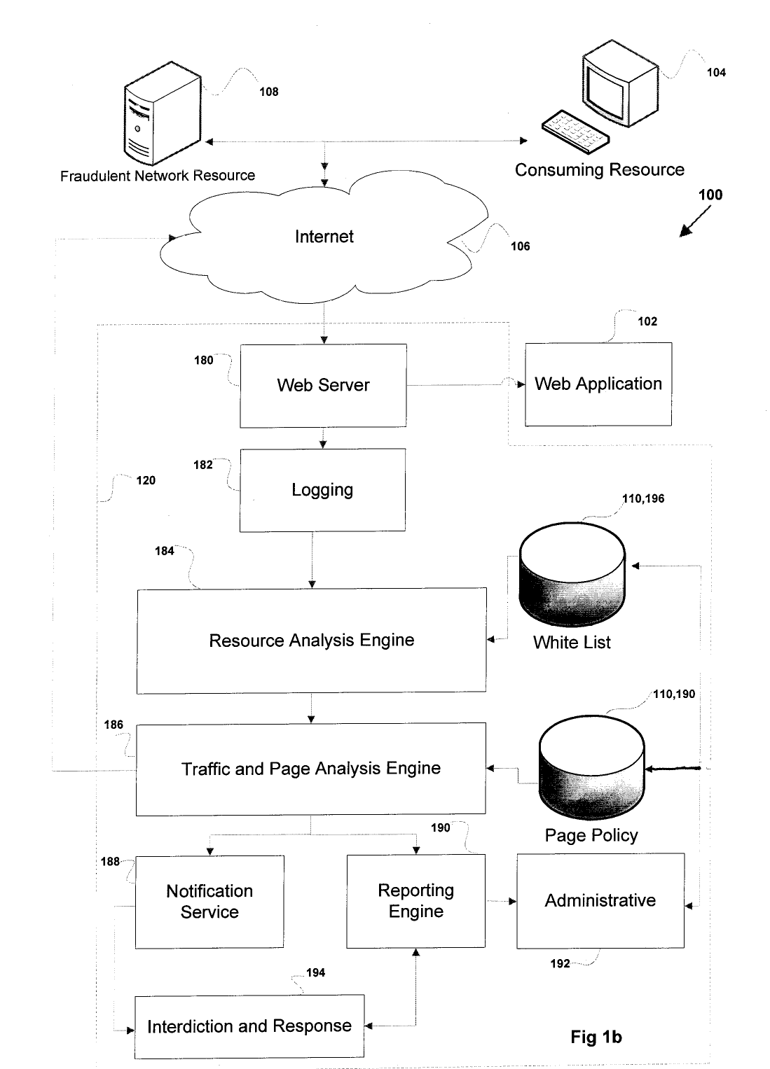

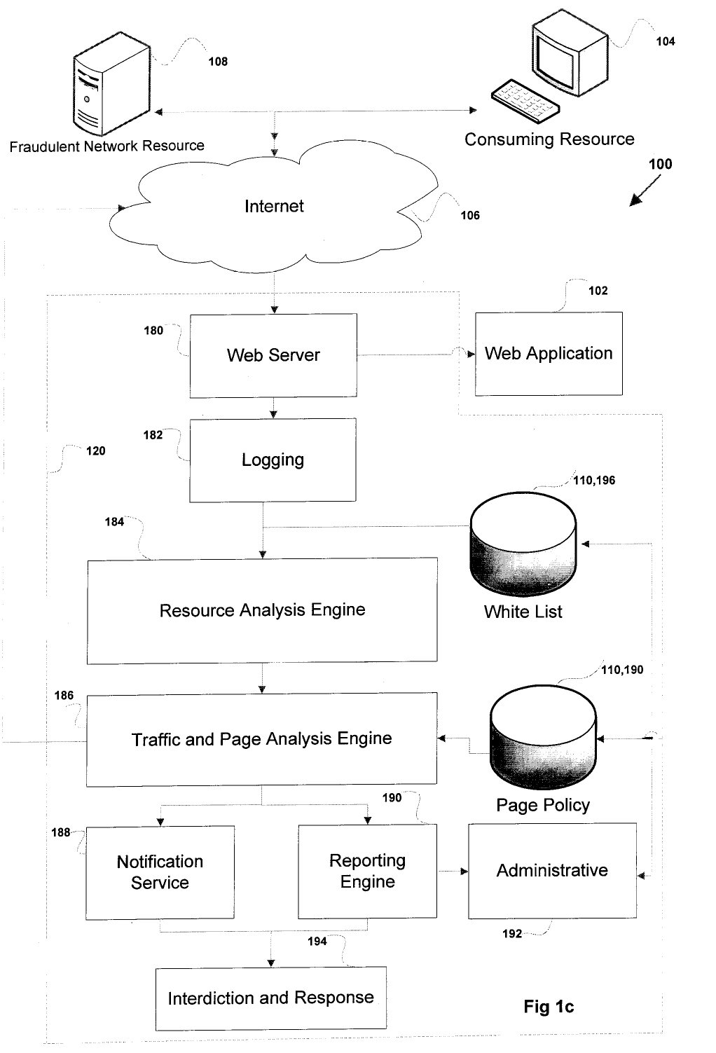

FIG. 1a is a schematic diagram of an embodiment of a computer network system providing an environment and comprising components suitable for use in implementing the invention. In the embodiment shown, network 100 comprises a potential target system 102 operated by, for example, a business or other entity engaged in profit or not-for-profit e-commerce, such as a bank, network retailer, charity, government, or other information service; one or more network user systems 104 operated by legitimate network users desirous of accessing data related to information or other services available through potential target 102; and system 108 operated by a Phisher or other user desirous of accessing data available through or disclosed to target system 102 for fraudulent, deceptive, or other illegitimate purposes.

In the embodiment illustrated, network 100 further comprises security resource 120 adapted for monitoring and analyzing signal traffic directed to and from target system 102 in order to identify and optionally defeat Phishing system(s) 108. In various embodiments security resource 120 can be provided in the form of a separate computer or server system, or as a separate application run on or otherwise in association with target system 102, or in any other form or configuration consistent with the purposes and disclosure herein.

Systems 102, 104, 108, 120 are communicatively linked by local, wide-area, or other network 106, such as the internet or other public or private electronic communications network. Such network may be hard-wired, wireless, or of any other form consistent with the purposes and disclosure herein.

As will be readily understood by those skilled in the relevant arts, a system or other network resource 102, 104, 108 can be considered to be “remote” from another resource, such as another system 102, 104, 108 when it is located on the other side of a network communications link, e.g., network(s) 106, such as system 102 and any of systems 104, 108 shown in FIG. 1a. When any two systems 102, 104, 108 are located on a same side of such a communications link, they may be said to be “locally” disposed with respect to each other.

Target system 102 can comprise one or more associated databases or other storage media 110 directly or indirectly controlled or otherwise accessible by the system 102. Media 110 can be used, for example, for storing data useful in presenting to users of systems 104 graphical or other user interfaces adapted for the presentation and other processing of information for any of the many uses enabled by network communications, and associated input, output, and/or other data processing functions.

Network user resources 104 can comprise any computers or other user systems, operating suitably-configured operating systems and/or applications software, suitable for use in accessing information accessible through system 102 and providing or otherwise processing associated input and output signals for suitable for controlling the corresponding communications processes, such as the negotiation and execution of sales, information downloading or exchange, and other transactions.

For example, in one embodiment target system 102 can be operated by a bank or other e-commerce venture accessible by one or more customers using user stations 104 to access and manipulate funds; apply for, accept and otherwise process loans and other services; etc. In accessing and controlling account information and other banking functions, users of one or more stations 104 can cause the respective systems 104 to provide to system 102, using suitable communications processes, with suitably-adapted command signals, including inquiry signals adapted for requesting access to information stored by system 102 on one or more of media 110. Such inquiry signals can be configured in accordance with a suitable communications protocol, such as for example HTTP, and can include one or more data items, or fields, comprising information such as a URL associated with the target system 102, the type of data content desired, and identifying the inquiring signal source 104.

Phishing or other fraudulent network resource 108 can be expected to be encountered in any of a wide variety of configurations. It can be implemented, for example, using a stand-alone desktop computer, or a combination of distributed resources communication via a network.

A user of a Phishing system 108 who desires to obtain account or other economically-useful or confidential information from one or more users of systems 104 may for example try to access information stored in one or more of databases 110 controlled by operator system 102 in order to obtain data useful in building a fraudulent or otherwise deceptive web site purporting to be operated by the operator of system 102, or under the authority or sponsorship thereof, and thereafter to masquerade as a legitimate web site and lure one or more users of systems 104 to access the fraudulent site and disclose information useful to the fraudulent operator. To that end, a user of Phishing station 108 can cause the station 108 to provide to system 102 signals intended to access one or more data sets stored on one or more of databases 110, make and/or modify the contents thereof, and store the appropriated or modified information in one or more databases controlled by or otherwise associated with the Phishing system 108. In doing so, the Phishing system 108 will often be caused to provide to system 102 inquiry signals configured in accordance with a suitable communications protocol, such as for example HTTP, which include one or more data items, or fields, comprising information such as a URL or other network identifier associated with the target system 102, the type of data content desired, and identifying the inquiring signal source 108.

Alternatively, an operator of a Phishing system 108 can attract users of network resources 104, e.g., user system 130, and network(s) 106 by displaying logos, text, images, or other content adapted to deceive such users into thinking that system 108 is owned or sponsored by, an advertiser associated with, or otherwise affiliated with target 102 in order to induce the users of systems 104 to disclose confidential or other information to the Phishing system 108. For example, by causing system(s) 104, 130 to display suitably-configured web pages or other user interfaces made accessible to the user(s) of system(s) 104 through fraudulent search techniques or suitable advertising, etc., an operator of a Phishing system 108 can induce a user of a system 104, 130 to send data to and receive data from the Phishing system 108, and can thereby cause the user of the system 104 or signals therefrom to be redirected or otherwise referred to the target system 102; and thereafter can monitor communications between the user resource 104 and the target system 102, and thereby copy or otherwise capture data entered by the user of system 103 and intended for processing by target 102 or other network resources, or for other purposes.

Thus, by monitoring incoming inquiry signals, an operator of system 102 or a security or other monitoring system 120 can identify, using network identifiers included in inquiry data signals as disclosed herein, systems 108 operated for fraudulent or other illegitimate purposes, and take further action to prevent or halt such activities as appropriate.

As will be readily appreciated by those skilled in the relevant arts, monitoring of inquiry signals sent for possibly illegitimate purposes can performed by the operator of the target system 102 or by a related or unrelated third-party security provider 120. Such monitoring may be fully or partially automatic, i.e., performed wholly or partially under the control of a suitably-programmed processor associated with either or both of systems 102, 120; and may be performed on a continuous, continual, periodic, or any other designated basis.

As will be further understood, the various aspects and devices used in implementing the invention may be provided in a wide variety of forms. Any system and/or programming architecture or other arrangement compatible with the purposes disclosed herein will serve.

Examples of other embodiments of systems 102, 120 suitable for implementation of methods and processes according to the invention are shown in FIGS. 1b and 1c. In the examples shown in FIGS. 1b and 1c, security system 120 is a locally-available or integral part of the target system 102.

In the embodiments shown in FIGS. 1b and 1c, target system 102 comprises a target application such as an online banking, payment, or information resource. Security resource 120 comprises a web server 180 configured to process incoming and outgoing signals, including inquiry signals received from consuming resource 104 directly, or via referral from fraudulent network resource 108. Authorized or other recognizable requests or input commands intended for use by target application 102 are directed thereto.

All incoming inquiry signals are also, however, processed by logging service 182, which maintains a separate, suitably-configured log of all such messages. Data records logged by logger 182 can comprise all or any useful or otherwise-desired portion(s) of inquiry signals received by web server 180, including for example network identifiers associated with the originating and/or referring resources 104, 130, 108, the content of such inquiries, including the nature or specific data requested, time and date of the receipt of the inquiry, and the type or nature of the application (such as a web browser) used in creating or delivering the inquiry. Such inquiries, and logged records thereof, can, as further discussed herein, be interpreted and/or otherwise processed in accordance with any suitable protocol(s), including for example HTTP.

Resource analysis engine 184 analyses received inquiry signals to determine, as disclosed herein, whether identifiers associated with the primary and/or secondary source(s) of the inquiries satisfy one or more trustworthiness criteria. For example, the resource analysis engine can compare network identifiers included with logged inquiry signals with identifiers known to be trustworthy, as for example those included in approved “white” list 196; or with identifiers known to be untrustworthy, as for example those included in a “black” list.

Traffic analysis engine 186 can further analyze received inquiry signals to determine whether content or other characteristics of received inquiry signals satisfy trustworthiness criteria. For example, the traffic analysis engine can compare content included with or otherwise represented by data included within such inquiry signals with content or other rules represented by data stored in page policy database 198.

If either resource analysis engine 184 or traffic and page analysis engine 186 determine that any aspect of a received inquiry signal do not satisfy any required trustworthiness criteria, a notification service 188 can be caused to forward suitable notices to security or other administrative or otherwise desirable recipients; reporting engine 190 can be caused to report the source(s) of the untrustworthy inquiry signal to be reported to appropriate authorities, and otherwise process the received inquiry signals.

Interdiction and response systems 194 can be caused to take action to disrupt fraudulent resource 108 or otherwise curtail possibilities of fraudulent activity.

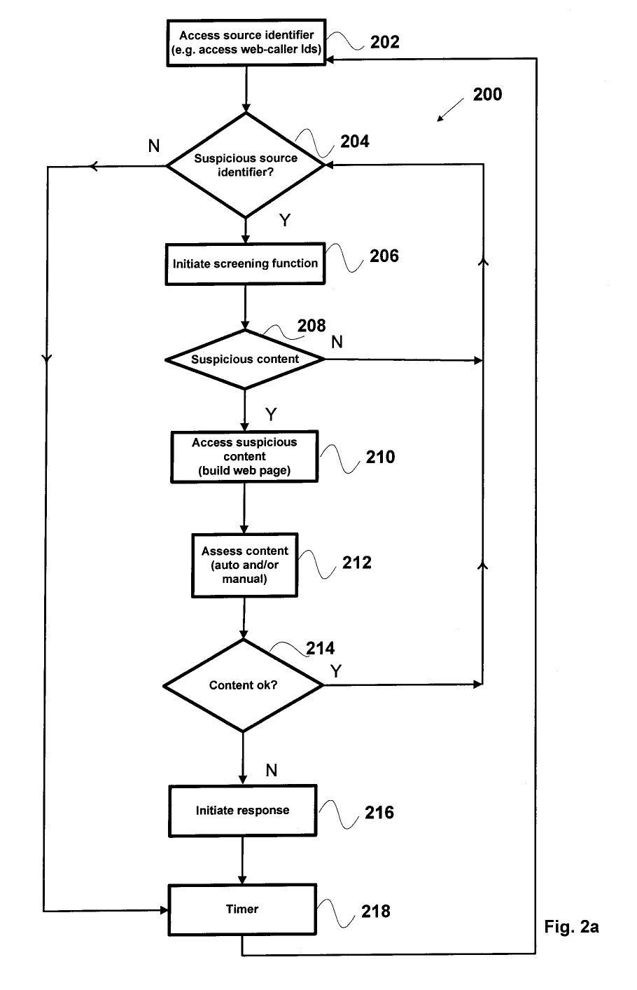

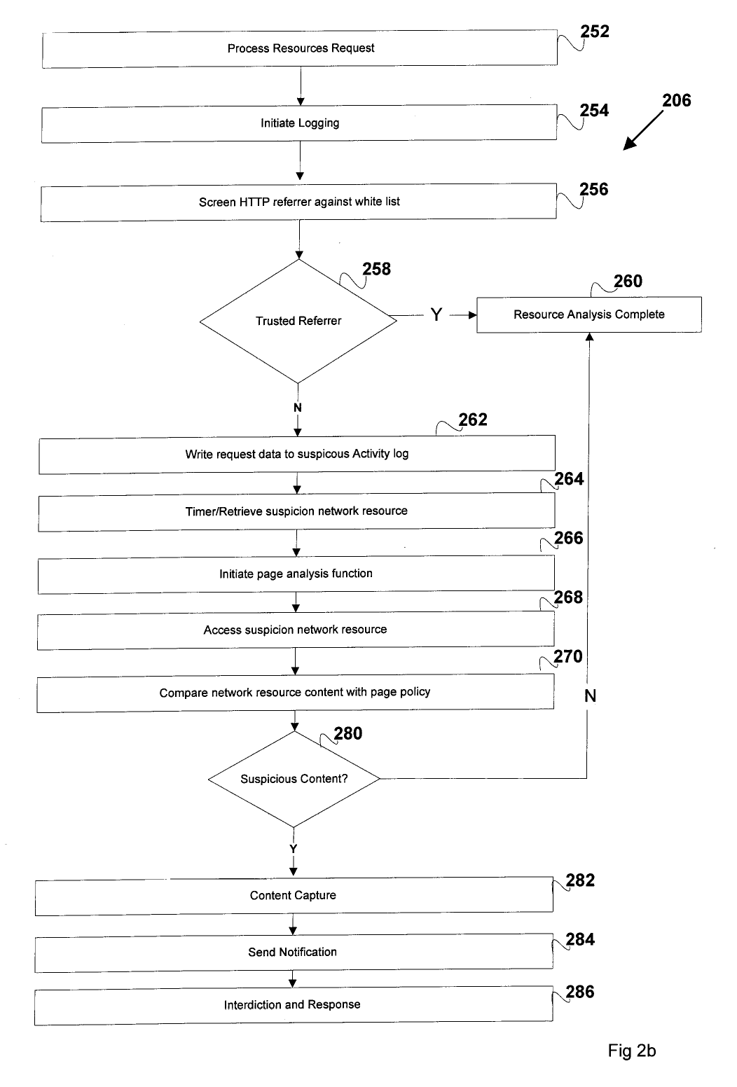

FIG. 2a is a schematic flowchart of a method of identifying potentially fraudulent activity on a computer network in accordance with the invention. Process 200 of FIG. 2 is suitable for implementation in an environment and using architectures such as, for example, those shown in FIGS. 1a-1c.

Specifically, in the embodiment shown in FIGS. 1a-1c, target systems 102, which may for example comprise network servers operated by e-commerce enterprise, and/or network security systems 120 comprise one or more computers or other data processors that can be configured to monitor signal source identifiers such as “referral” tags included in data provided as part of inquiry signals originated by remote computers such as customer PCs 104 through Phishing systems 108. For example, as mentioned, communications are frequently implemented according to the HTTP protocol, which includes a number of data fields, including an “IP address” field used to provide the URL or other identifier of the remote computers from which a data request has originated and one or more “referral” fields used to identify the network resource(s) 108 from which such signals were received or were otherwise referred. Such originating and referral tags can be retrieved and analyzed using, for example, proprietary or commercially-available “web-caller ID” processes.

A variety of suitable communications protocols and “web-caller” ID processes are known, and doubtless others will hereafter be developed. For example, HTTP referrer values may be provided by network browsers operated by customer PCs 104 in accordance with W3C HTTP.1.1 standards/RFC2616, as provided at http://www.w3.org/Protocols/rfc2616-sec14.html#sec14.36, the entire contents of which are incorporated by this reference.

An example of an inquiry signal comprising originating and referral source identifiers is as follows:
216.145.101.117—[15/Jun/2006:08:53:48-0400] “GET/blank.jsp HTTP/1.1” 200 12 “http://d01.webmail.aol.com/17789/aol/en-us/Mail/get-attachment.aspx?uid=1.12923361&folder=New+Mail&partID=4&saveAs=EasyWebjanuary05.htm” “Mozilla/4.0 (compatible; MSIE 6.0; Windows NT 5.1; SV1; .NET CLR 1.14322)” “BrandReferrer=www.tdcanadatrust.com”

In this example the inquiry signal comprises data “216.145.101.117” representing the IP, or originating, address of the message, that is, the system 104 from which the message originated; the time and date “[15/Jun/2006:08:53:48-0400]” at which the message was sent by the originating system 104; the encoded content of the request ““GET/blank.jsp HTTP/1.1” intended by the originating system 104 for the target system 102, as possibly modified by the referring system 108; the referral tag, or the network identifier of the originating system 108” http://d01.webmail.aol.com/17789/aol/en-us/Mail/get-attachment.aspx?uid=1.12923361&folder=New+Mail&partID=4&saveAs=EasyWebjanuary05.htm”; and data “Mozilla/4.0 (compatible; MSIE 6.0; Windows NT 5.1; SV1; .NET CLR 1.14322)” representing the type and version of the browser or other operating system used to create the message; and a brand referrer field “BrandReferrer=www.tdcanadatrust.com”.

It should be noted that either an originating signal source (e.g., IP address) or a referring source can be considered to be the source of an inquiry or other signal source for purposes of this disclosure.

At 202 one or more processor(s) associated with network security system 102, 120 monitor incoming inquiry signals received from user systems 104 and Phishing system(s) 108. For example, the processor(s) can read all incoming inquiries and can cause web-caller IDs, referral tags, and/or other signal source identifiers to be stored in volatile or permanent memory such as a buffer, RAM, or fixed media 110, along with any other desired information, including for example data corresponding the type or specific information requested from the target system 102, the time and date of the inquiry, etc.

Monitoring by target system 102 and/or security system 120 of incoming inquiry signals can be performed on a continuous, continual, periodic, or other desired basis, so as to ensure, for example, that all incoming inquiries are screened. In some embodiments the network security system 102, 120 compiles a list of all inquiry signal source identifiers associated with network resources from which requests for data have originated and further processes them, in accordance with this disclosure on a batch or other delayed basis. In other embodiments each source identifier is processed in real time, i.e., as quickly as practicable following receipt, as for example where such processing is a condition of authentication or other means of authorizing access to data available through the target system 102.

At 204 each desired acquired signal source identifier is checked to determine whether it meets one or more trustworthiness criteria. A wide variety of criteria may be used, alone or in combination, to assess the trustworthiness of inquiry sources. For example, the inclusion of an originating or referring signal source identifier on a list of previously-established or otherwise recognized customers or referral sources, will serve. For example, in such a case the inclusion of a source identifier associated with a request for data can be accepted as an indication that the source from which the inquiry originated is trustworthy.

Alternatively, inclusion of an originating or referral signal source identifier on a list of resources previously identified as associated with suspicious activity can serve as an indicator that the inquiry source is not trustworthy. As another example, the repeated receipt of requests for data from the target system 102 from one or more individual inquiry sources within a designated period of time, or other usual or suspicious inquiry pattern, can be used to identify a signal source identifier as untrustworthy. For example, requests from a single inquiry source for a systematic downloading of all or any significant or unusual portion of publicly-accessible data provided on a web site associated with target system 120 can be deemed an indication that the requesting signal source is not trustworthy.

It is known, for example, that constructors of fraudulent web resources sometimes use automatic means to access data available on a target system 102. It is possible, by tracking which data available through the target resource 102 is accessed by a given network resource, to determine whether the requesting resource is accessing the data automatically. In some circumstances, as will be understood by those skilled in the relevant arts, the automatic accessing of data can be interpreted as a sign of illegitimate activity, and the originating and/or referring resource identifiers can be deemed suspicious. Thus various forms of traffic analysis can be used to provide trustworthiness criteria suitable for use in implementing the invention.

Any individual or combined criteria consistent with the purposes and processes disclosed herein will serve.

For example, at 204 the network security system 102, 120 can review a list of tags associated with incoming data requests collected at 202 to determine whether any new or otherwise unknown referral tags have been identified. Most entities operating systems according to the invention can be expected to know or otherwise recognize, either through past, appropriate dealings or through inclusion in approved ‘white’ or ‘safe’ lists, referral tags associated with legitimate referral sources, and other legitimate users. It is less likely that source identifiers associated with Phishers and other potential other abusers will be known to the operator of the target resource 102 and/or security resource 120, or recognized in the list. Thus inclusion of a source identifier in an pre-determined list of authorized users and/or referrers can be used as a trustworthiness criteria.

In some embodiments, assessments of individual source identifiers as trustworthy can be rescinded, so that both previously trusted and/or previously untrusted sources can be reassessed for new fraudulent or legitimate activity.

If at 204 a source identifier has been determined to be untrustworthy, at 206 a screening function may be activated by security system 102, 120. The screening function may be adapted, for example, to access and analyze information identifiable through or otherwise associated with the network resources identified by the source identifier(s) analyzed at 204. Such information can include, for example, data files suitable for use in the assembly and presentation of web pages stored on media or computers 116 associated with resources associated with the unknown signal identifiers.

The screening function may be initially or fully implemented automatically by the security system 102, 120 and/or with the intervention of a human operator of the system 102, 120. For example, a network site associated with an untrusted signal source identifier can be accessed by the security system 102, 120, and any and/or all accessible data can be assessed for similarity to or inclusion of data used in the target site 102, such as a logo, identifiable log-in screen, image, or other content, to determine whether the untrusted resource 108 is potentially being used or set up to impersonate a legitimate site or otherwise gather information from a user of a system 104.

Thus at 208 the screening function activated at 206 can access information associated with the unknown referral tag and analyze it for inclusion of any suspicious content, including for example either images or text. Suspicious content can include, for example, logos, trademarks, or other information associated with the operator of the target system 102 and not authorized for outside use. For example, an e-commerce firm operating a system according to the invention can analyze accessed content for unauthorized use of its own logos, trademarks, or other information, or for content adapted to elicit confidential information from the firm's customers or business partners.

If at 208 no suspicious content is identified, any remaining untrusted signal source identifier(s) identified at 204 may be checked by repeating the process 206-208 until all untrusted identifiers have been checked.

If at 208 content accessed by the security system 102, 120 is determined to be suspicious, at 210 the system 102, 120 can use the accessed data construct any web pages or other GUI or interface information the suspicious content is intended to be used for, and at 212 use the information to assess the suspicious content, and determine whether the data associated with the remote signal source comprises data useable for providing a user interface screen adapted to elicit confidential information from a accessor of the data. For example, if the accessed content is intended to form part of a “Phishing” web site operated by a Phishing site 108 for fraudulent purposes, the security system 102, 120 can construct the web page as it would be presented to one of the firm's legitimate customers or business partners, for review by a human analyst or enforcement agent.

The assessment made at 210 can be made automatically and/or manually, by suitably-adapted image/content recognition software and/or by human operators.

If at 212, 214 the accessed content is determined to be fraudulent or otherwise suspicious, at 216 an internal or external referral can be made for follow-up and/or enforcement action, such as freezing threatened or fraudulent accounts, shutting down a fraudulent website, etc. Such referral(s) can be made automatically by the security system 102, 120, and/or manually by a human operator of the security system. As will be appreciated by those skilled in the relevant arts, in some circumstances the discretion afforded by human intervention can be useful in avoiding false accusations or other potentially embarrassing situations. Conversely, automatic notification can be very rapidly implemented, so that the opportunity for fraudulent behavior by an operator of a suspicious site 108 can be minimized.

Follow-up and enforcement action initiated at 216 can include any measures suitable for mitigating risk of fraud or other authorized access to or accumulation of data by an untrusted signal source 108, including for example password suspension, telephone or other human-initiated follow-up to legitimate system users 104 to determine whether any confidential information may have been compromised, and/or freezing of any customer and/or other accounts controlled by or otherwise associated with the target system 102.

If at 214 the content is determined not to be fraudulent, suspicious, or otherwise inappropriate, any remaining unknown referral source identifier(s) identified at 204 may be checked by repeating the process starting at 206 until all unknown resources have been checked.

As previously mentioned, investigation of inquiry sources determined to be untrustworthy can be made in real time, near real time, or after a delay or within a maximum time period of any desired or advantageous duration. For example, confirmation of an inquiry source as trustworthy can be made a condition of access to the operator's network resources, as for example during a log-in or other authentication process. Alternatively, as for example where it is not desired to slow the user authentication process, it can be advantageous to assemble sets of identifiers for batch or other more or less “off-line” or delayed processing. For example, by monitoring identifiers of incoming inquiries and holding data corresponding to such identifiers in a buffer or other data set, it is possible to allow legitimate users to access the operators resources without delay. In such circumstances suitable periods for delay, or establishment of suitable time limits for confirmation or other investigative follow up can be used to minimize harm done by the implementation of fraudulent websites. It has been found, for example, that checking the source of each incoming inquiry within a few minutes, as for example within 15 minutes or half an hour, can provide effectively rapid response.

Accordingly, at 218, at specified intervals, the process 202-216 can be repeated. The interval specified at 218 can be determined based on any appropriate or suitable factors, including for example the convenience of legitimate customers or business partners of the entity operating the target system 102, and can be set to an arbitrarily short time, including for example zero, so that the process is performed as continuously and as close to real-time as may be practicable.

Thus a determination as to whether a network identifier associated with the remote signal source satisfies at least one trustworthiness criterion may be performed within a predetermined time, as for example within 30 minutes or less; or the determination may be made after a desired minimum delay, as for example of at least 5, 10, or more minutes. Likewise, such determinations may be made within defined windows bounded by both minimum and maximum delays.

Thus the invention provides, among other features and advantages, near real-time assessment of Phishing or other fraudulent activities, with options for unprecedentedly quick, yet appropriate enforcement action. By providing flexible and adequate opportunities for automatic and/or human review of identified websites, the invention offers increased speed and efficiency in identification of fraudulent activity, with minimal “false-positive” identification and inconvenience to legitimate network users.

FIG. 2b is a schematic flowchart of a method of identifying potentially fraudulent activity on a computer network in accordance with the invention. Process 250 of FIG. 2b is suitable for implementation in an environment and using architectures such as, for example, those shown in FIGS. 1a-1c.

At 252 target system 102, operating in cooperation with security resource 120 can process any or all incoming inquiry signals, or resource requests. Specifically, for example, web server 180 can cause each incoming inquiry signal to copied or otherwise forwarded to a persistent memory by a logging engine 182, for storage possible later processing or reference.

At 256 resource analysis engine 184 can, as described herein, parse the incoming inquiry signal; and can analyze relevant portions of the signal, including for example the originating and referring source identifiers, to determine whether the originating and/or referring source identifiers are trusted.

If the signal source is determined to be untrustworthy, at 262 some or all of the data comprised by the inquiry signal can be written to memory in a suspicious activity log or other data set, which may be a specialized log different from the routine traffic log invoked at 254. If desired, such data may accumulated for a pre-determined or other desired time, and at 264, at the pre-determined time or on command of a system administrator or other user, the suspicious activity log may be retrieved from memory or otherwise accessed, and at 266-270, as described herein, a suspicious resource analysis function can be initiated, automatically or at the command of a system user. The analysis can include, at 270, application of “page policy” rules to determine whether content is suspicious. For example, a page policy implemented as a rules database 198 (FIGS. 1b, 1c) can be used to determine whether a data set associated with a network resource determined to be untrustworthy contains images, text, or other content deemed to be suspicious. For example, an e-commerce enterprise operating a target system 102 might consider it suspicious for an unknown, and therefore unsponsored or otherwise unaffiliated network resource to be storing logos, specified key words, or other information owned or otherwise controlled by or associated with the e-commerce enterprise.

If the content analyzed at 266-270 is determined to be suspicious, content associated with the untrusted signal source can at 282 be captured by, for example, accessing the content in a systematic manner, and storing copies of it for later automatic and/or human review.

When the suspicious content has been captured and safely stored for review, at 284 a notification, as for example an e-mail or other electronic alert, can be sent to security or other users to inform them that suspicious content has been identified and is waiting for review. Thus at 286 the content can be reviewed, and appropriate interdiction and response action may be taken.

In an example embodiment of process 250 of FIG. 2a, notifications can be provided in multiple levels. For example, at a first instance, a technical risk management operator can be informed, to perform an internal review of the suspicious content. If the risk management operator is persuaded that the suspicious content warrants further action, a supervisory user can be notified, optionally at the initiative of the first operator. Similarly, if deemed warranted by the supervisory user, the content and untrusted signal source can be reported to external administrative or legal enforcement agencies.

Among the many advantages offered by the invention is the possibility of correlating all data identified as associated with untrusted sources 108, so that for example all transactions which may have originated from an untrusted site may be investigated. For example, in a case in which a Pharming or other fraudulent website has been set up to acquire confidential customer information, and the information is later used in an attempt to defraud the target site 102, all transactions related to the untrusted site may be identified and investigated as appropriate. All data strings received in such cases may, for example, be associated with tags or other identifiers, and stored in suitable data bases or other data structures for appropriate further investigation. This can be especially useful in, for example, allowing customers of a target resource 102 to check their records to determine whether they have been made victims of fraud.

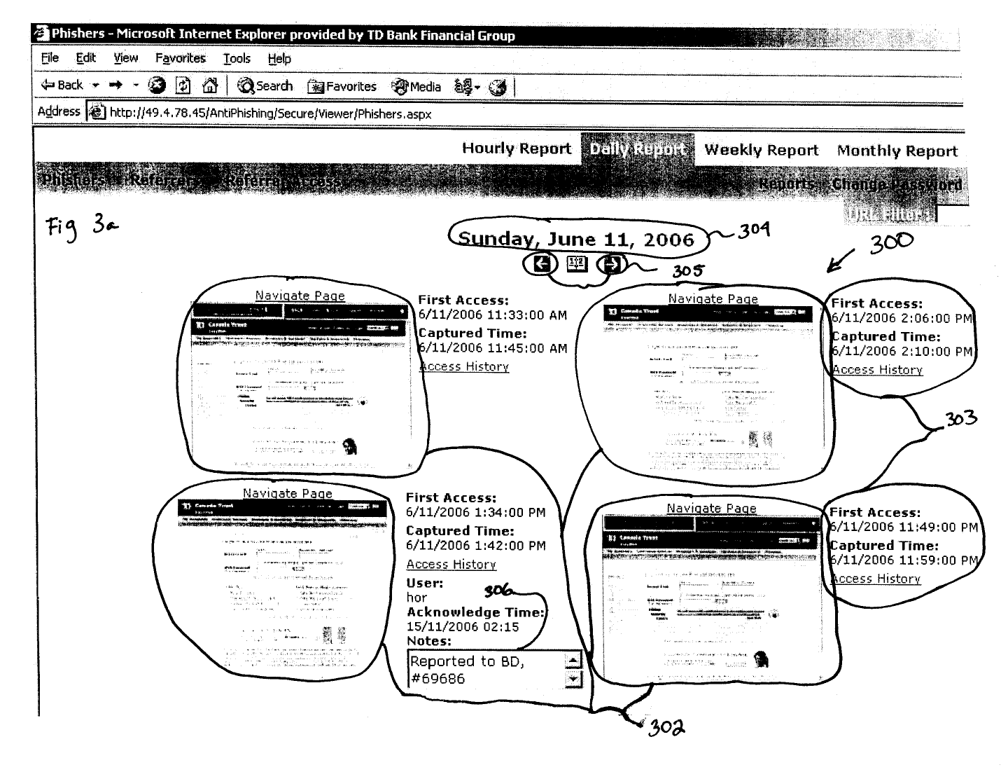

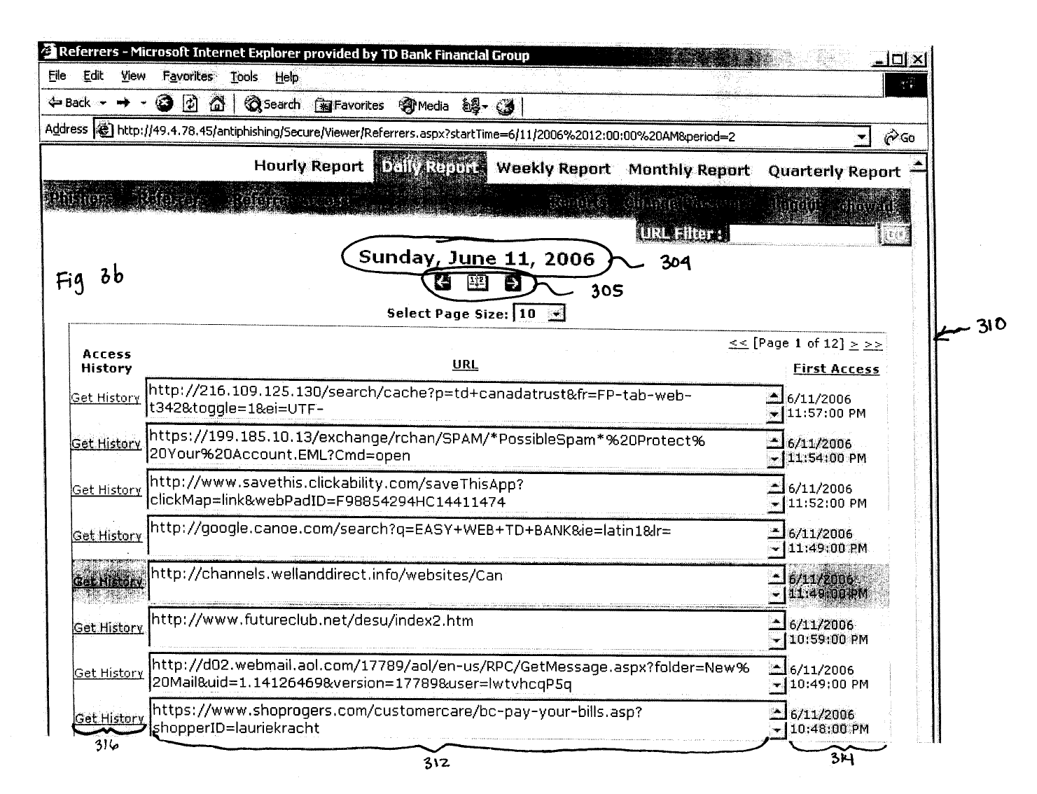

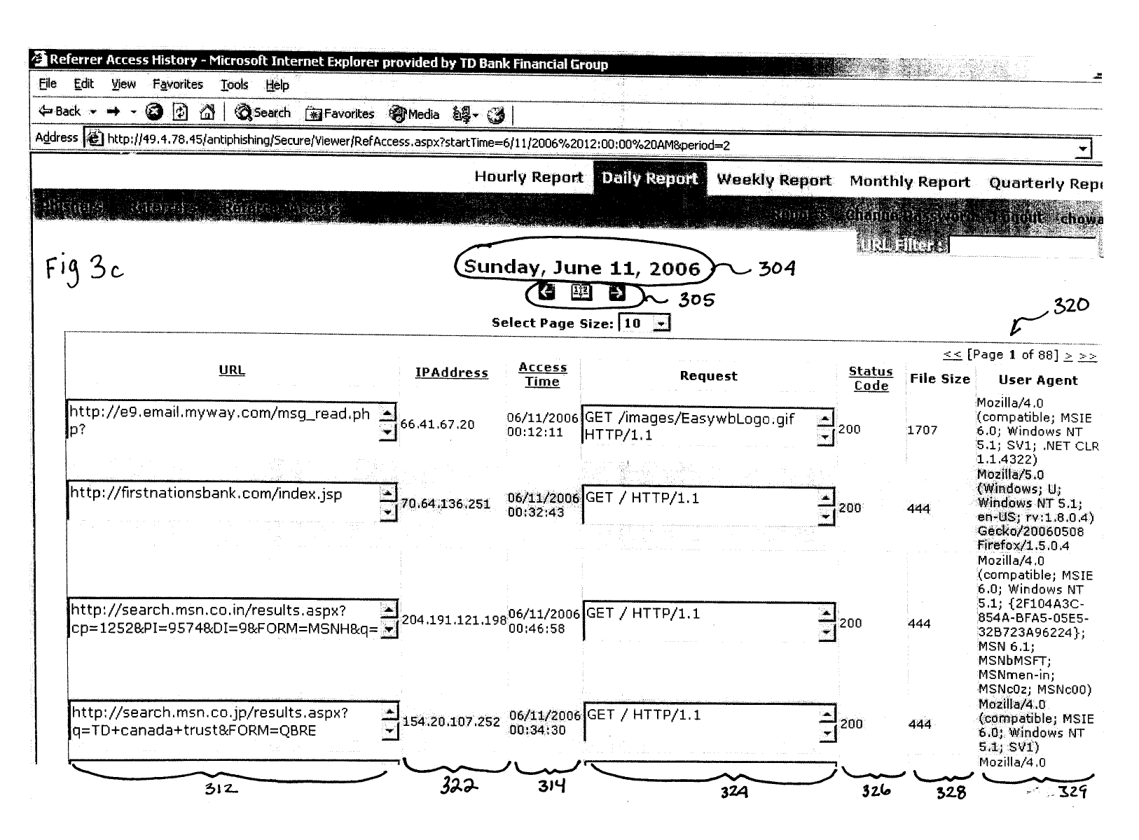

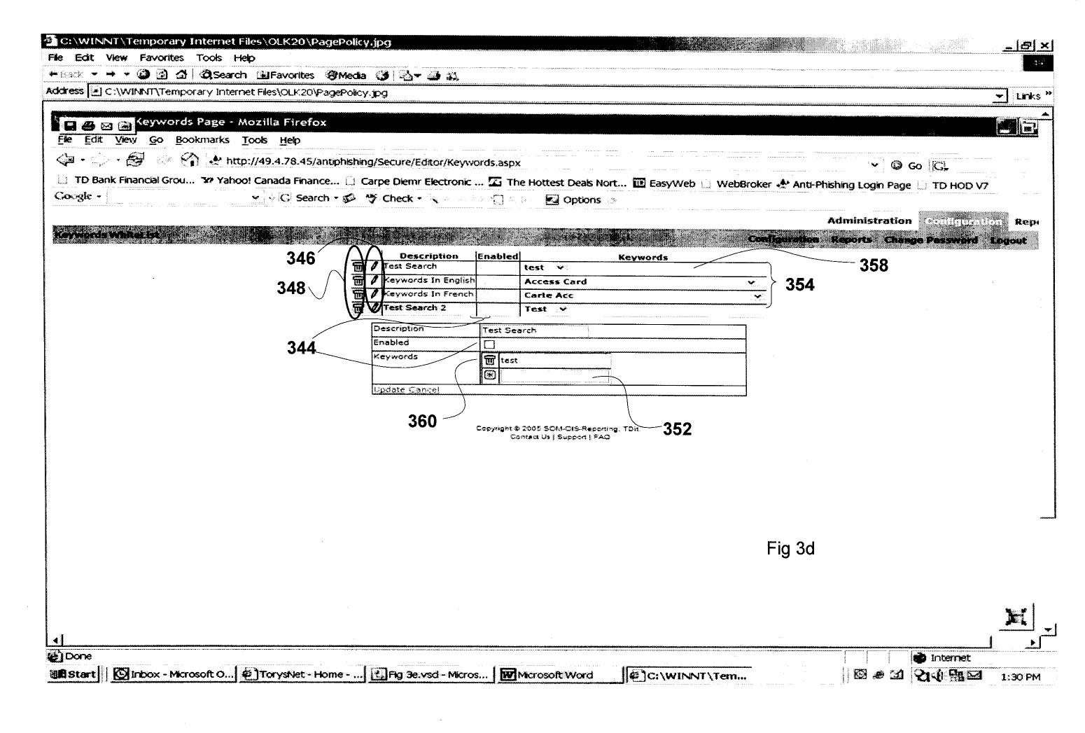

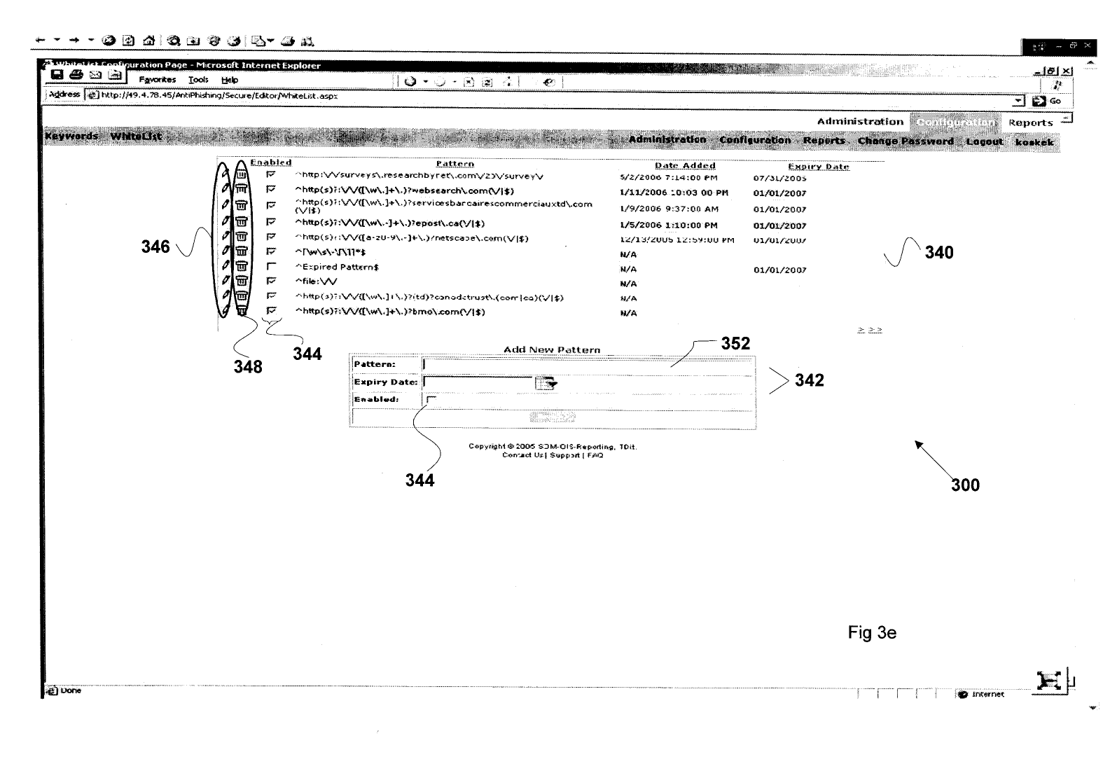

FIGS. 3a-3e are schematic diagrams of user interface display screens suitable for use in implementing the invention.

Screen 300 of FIG. 3a is an example of a user interface screen which can be provided to a security analyst user of a target system 102 and/or a security resource 120 at process steps 282-286 of FIG. 2b, and is suitable, for example, for implementation by a Windows™-style operating system to facilitate input/output by a suitable user in interactively controlling a security system 102, 120. A screen 300 can be displayed for such a user when, for example, at 210, 214 in a process 200 the security system 102, 120 has identified an untrusted signal source 108 and has accessed data associated with the untrusted source.

The data retrieved from the untrusted source can be displayed in, for example, “thumbnail” form, in one or more fields 302 so that the security user can easily review it for illegitimate purpose. Interactive items adapted for selection using Windows™-style “point-and-click” methods can be provided for initiating and controlling various investigative functions, including for example “Navigate Page” items which can cause an enlarged, interactive version of the depicted page to be displayed, with some or all of the functionality intended to be provided by the untrusted resource 108 from which the content was captured. Fields 303 can be provided to display data indicating, for example, the time and date at which the suspicious content was first accessed, the time at which its capture was completed; and any history of the system 102, 120 in accessing and capturing the content, or any history of the untrusted resource 108 in accessing or attempting to access the target system 102 can be displayed using a suitable selectable item such as a hypertext link “Access History.”

As shown in process 250 of FIG. 2b, suspicious content can be captured and stored for archiving and later review as necessary or desired. Thus screen 300 can provide at 304 interactive items suitable for use in reviewing content captured during various pre-determined or selected time periods. For example each of the thumbnails 302 shown in FIG. 3a can represent content captured on a single day, e.g., 11 Jun. 2006, and Windows-style arrows 305 can be provided to permit navigation through previous or subsequent days, as desired. As will be readily understood by those skilled in the relevant arts, periods used for display can include single or ranges of hours, days, weeks, months, etc. Any suitable time periods or ranges can be used.

Where appropriate or otherwise desired, one or more interactive notes fields 306 can be provided to enable authorized users to associate annotations with various captured data sets.

FIG. 3b illustrates an example of an alternative or additional view of captured data that may be provided to users of system(s) 102, 120. Screen 310 of FIG. 3b provides a listing, arranged by referring signal source identifiers, of untrusted signal sources from which image or other data was captured within a given time period. Column 312 of FIG. 3b provides a listing of referring signal sources identified at 258-280 and/or 210-214 of FIGS. 2b, 2a respectively, as untrustworthy, formatted according to the HTTP protocol. Column 314 provides date and time of first access, and column 316 provides hypertext links to complete access histories, as at items 303 of screen 300 of FIG. 3a.

FIG. 3c illustrates a further example of an alternative or additional view of captured data that may be provided to users of system(s) 102, 120. Screen 320 of FIG. 3c provides listings of various data items included in inquiry signals captured by system 102, 120 at, for example, 202 and/or 252, 254 of FIGS. 2a, 2b, respectively. Column 312 of FIG. 3c provides a listing of referring signal sources identified at 258-280 and/or 210-214 of FIGS. 2b, 2a respectively, as untrustworthy, formatted according to the HTTP protocol. Column 322 provides the originating signal sources associated with the respective inquiry signals; column 314 the date and time of first access. Column 324 provides the content of the request included with the inquiry signal, and column 326 the HTTP-standard status of the request at the time the information is displayed in Screen 320. Column 328 provides the size, in bytes, of the requested data; and column 329 identifies the browser or other operating system used by the referring resource 312 to forward the inquiry. As will be readily understood by those skilled in the relevant arts, each of the data items displayed in screen 320, as well as in screens 300 and 310, can be used advantageously in assessing whether an inquiry signal, and therefore the originating and/or referring signal source(s), are trustworthy.

FIGS. 3d and 3e show interactive user screens useful in establishing rules useful as trustworthiness criteria in assessing the content of inquiry signals and/or content accessed at suspicious network resources, as applied at, for example, step 270 of process 250 of FIG. 2b. The various interactive items shown in screens 330, 340 can be used to create and control the application of desired rules. Screen 330, for example, is suitable for creating rules comprising specified key words as criteria, and, by for example using items 344, selectively enabling or disabling them; screen 340 provides a listing of established pattern criteria and for creating and modifying new patterns. As shown at 342, rules can be established for time-limited periods. Items 346, 348 can be selected to activate editing and/or delete functions, respectively. In FIG. 3d, field 352 can be used for entering key words to be used in a new rule entitled “Test Search”. Key words associated with previously-established rules can be reviewed in field 354. In the example shown, the previously-established rule 358 labeled “Test Search”, which is associated with a key word “test” has been disabled and an editing function has been initiated for it, so that the keyword “test” can be deleted, as for example by selecting “delete” item 360, and/or additional key words can be added by placing a cursor in field 352 and inputting suitable characters, by for example using a keyboard.

Data processing/database searching, matching, and other functions suitable for use in implementing the systems, methods, and processes disclosed herein may be accomplished by any suitable means, including a wide variety of known and commercially available methods, software, and systems. The identification and implementation of suitable processes will not trouble those skilled in the relevant arts, once they have been made familiar with this disclosure.

While the foregoing invention has been described in some detail for purposes of clarity and understanding, it will be appreciated by those skilled in the relevant arts, once they have been made familiar with this disclosure, that various changes in form and detail can be made without departing from the true scope of the invention in the appended claims. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

What is claimed is:

1. A method of identifying potentially fraudulent activity on a computer network, the method performed by a data processor and comprising:
receiving a communication signal over a network from a remote signal source, the signal representing a request for access by the remote signal source to data and comprising a network identifier associated with the remote signal source;
determining whether the network identifier associated with the remote signal source satisfies at least one trustworthiness criterion; and
if the network identifier associated with the remote signal source does not satisfy the at least one trustworthiness criterion, accessing data associated with the remote signal source.

2. The method of claim 1, wherein the network identifier associated with the remote signal source is a referral source identifier.

3. The method of claim 1, wherein the network identifier is encoded according to the Hypertext Transfer Protocol.

4. The method of claim 1, wherein the at least one trustworthiness criterion comprises whether the network identifier associated with the remote signal source can be identified with a previously-assigned access authorization.

5. The method of claim 4, wherein the previously-assigned access authorization is assigned on the basis of a recognized referral relationship.

6. The method of claim 1, wherein the at least one trustworthiness criterion comprises a contemporaneously-assigned trust indicator based at least partly on a signal traffic analysis.

7. The method of claim 1, wherein the at least one trustworthiness criterion comprises absence from a previously-assembled list of suspicious network resources.

8. The method of claim 1, wherein the data associated with the remote signal source comprises data useable for the presentation of images.

9. The method of claim 1, wherein the data associated with the remote signal source comprises data useable for providing output useful in the presentation of an image.

10. The method of claim 1, wherein the data associated with the remote signal source comprises data useable for providing output representing text.

11. The method of claim 1, wherein the data associated with the remote signal source comprises data useable for providing a user interface screen adapted to elicit confidential information from an accessor of the data.

12. The method of claim 1, wherein the determination whether enforcement action is indicated is made at least partially automatically by the data processor, according to at least one pre-established criterion.

13. The method of claim 1, wherein the determination whether enforcement action is indicated is made at least partly by a human being upon consideration of the data associated with the remote signal source.

14. The method of claim 1, comprising at least one of the data processor and a human user assessing the accessed data associated with the remote signal source and determining whether enforcement action is indicated.

15. The method of claim 14, wherein the enforcement action comprises referral of the remote signal source to an enforcement agency.

16. The method of claim 14, wherein the enforcement action comprises a disruption of accessibility to data associated with remote signal source.

17. The method of claim 1, wherein the determining whether the network identifier associated with the remote signal source satisfies at least one trustworthiness criterion is performed within a predetermined time.

18. The method of claim 17, wherein the predetermined time is less than thirty minutes.

19. The method of claim 1, wherein the determining whether the network identifier associated with the remote signal source satisfies at least one trustworthiness criterion is performed after a predetermined delay.

20. The method of claim 19, wherein the predetermined delay is at least 10 minutes.

21. A system useful for identification of fraudulent activity on a computer network, the system comprising at least one data processor and computer programming media adapted to cause the at least one data processor to:
receive a communication signal over a network from a remote signal source, the signal representing a request for access by the remote signal source to data and comprising a network identifier associated with the remote signal source;
determine whether the network identifier associated with the remote signal source satisfies at least one trustworthiness criterion; and
if the network identifier associated with the remote signal source does not satisfy the at least one trustworthiness criterion, access data associated with the remote signal source.

22. Computer programming media adapted for causing a data processor to:
receive a communication signal over a network from a remote signal source, the signal representing a request for access by the remote signal source to data and comprising a network identifier associated with the remote signal source;
determine whether the network identifier associated with the remote signal source satisfies at least one trustworthiness criterion; and
if the network identifier associated with the remote signal source does not satisfy the at least one trustworthiness criterion, access data associated with the remote signal source.

23. The media of claim 22, wherein the network identifier associated with the remote signal source is a referral source identifier.

24. The media of claim 22, wherein the network identifier is encoded according to the Hypertext Transfer Protocol.

25. The media of claim 23, wherein the at least one trustworthiness criterion comprises whether the network identifier associated with the remote signal source can be identified with a previously-assigned access authorization.

26. The media of claim 25, wherein the previously-assigned access authorization is assigned on the basis of a recognized referral relationship.

27. The media of claim 22, wherein the at least one trustworthiness criterion comprises a contemporaneously-assigned trust indicator based at least partly on a signal traffic analysis.

28. The media of claim 22, wherein the at least one trustworthiness criterion comprises absence from a previously-assembled list of suspicious network resources.

29. The media of claim 22, wherein the determining whether the network identifier associated with the remote signal source satisfies at least one trustworthiness criterion is performed within a predetermined time.

30. The media of claim 29, wherein the predetermined time is less than thirty minutes.

31. The media of claim 22, wherein the determining whether the network identifier associated with the remote signal source satisfies at least one trustworthiness criterion is performed after a predetermined delay.

32. The media of claim 31, wherein the predetermined delay is at least 10 minutes.
